(19) United States
(12) Patent Application Publication
(10) Pub. No.: US 2018/0194388 A1
(43) Pub. Date: Jul. 12, 2018

(54) Electric Power Converter and Electric Power Steering Apparatus Mounting Same

(71) Applicant: Hitachi Automotive Systems, Ltd., Hitachinaka-shi, Ibaraki (JP)

(72) Inventor: Shigehisa AOYAGI, Tokyo (JP)

(21) Appl. No.: 15/740,516

(22) PCT Filed: Jun. 27, 2016
(86) PCT No.: PCT/JP2016/068984

§ 371 Date: Dec. 28, 2017

(30) Foreign Application Priority Data
Jul. 10, 2015 (JP) 2015-138264

(51) Int. Cl. B62D 5/04; B62D 6/00; H02M 7/493; H02M 1/14

(52) U.S. Cl. CPC B62D 5/04; H02M 1/14; H02M 7/493; B62D 6/00

(57) ABSTRACT

An object of the present invention is to realize high-performance motor driving control by detecting DC currents to reproduce AC currents with high accuracy in an electric power converter in which a plurality of inverters are connected to a motor either independently or in parallel. The present invention is characterized in that a predetermined current detection period in which a first current detection section detects a DC current of a first inverter is controlled in such a manner that the predetermined current detection period does not overlap at least timing of changing over between on-timing and off-timing of a switching element that configures a second inverter. More preferably, the predetermined current detection period in which the first current detection section detects the DC current of the first inverter is controlled in such a manner that the predetermined current detection period does not overlap periods in which a current is carried to the second current detection section.

### TECHNICAL FIELD

The present invention relates to a plurality of electric power converters connected in parallel and an electric power steering apparatus mounting the same.

### BACKGROUND ART

An electric power converter such as an inverter controls currents of a polyphase rotating electrical machine by PWM (pulse width modulation). If the rotating electrical machine is a three-phase motor, then a voltage command value applied to each of three-phase windings is compared with a carrier signal that acts as a reference for the PWM, and switching elements of a three-phase inverter are each changed over between an on-state and an off-state. Three-phase winding currents are thereby controlled. An output torque and a rotational speed of the three-phase motor are controlled to desired values by the three-phase winding currents.

To control a winding current, it is important to exercise current control in such a manner as to detect an actually carried current to feed back a current detection value, and to cause the winding current to follow a current command value that is the desired value. A current detector such as an ACCT that detects three-phase currents carried to the motor is used for current detection. The current detector disadvantageously causes increases of a loading volume and a cost. As a scheme for solving the problems, there is a well-known technique for detecting a current carried to a shunt resistor installed on a DC side of an inverter and thereby detecting the current as each of three-phase currents carried to the motor.

The winding current carried to the motor is carried to the shunt resistor as a pulse current depending on whether the switching elements of the inverter are in turned on or off. The pulse shunt current is detected as the winding current of the motor. It is noted that ringing entailed by turning on and off the switching elements occurs to the pulse shunt current. To detect an accurate current value, it is necessary to avoid a period in which this ringing occurs.

Meanwhile, if a plurality of three-phase inverters are configured to be connected in parallel, it is possible to increase a current capacity of the inverters. Alternatively, two or more systems are configured such that each system is a combination of windings of a three-phase motor and a three-phase inverter that are connected in one-to-one correspondence. In this case, even if one of the systems fails, the other system or systems can continue to operate. In any of the configurations, it is necessary to control an output from each inverter. Owing to this, it is necessary to provide current detectors that detect output currents from the inverters, and an increase in the number of inverters causes an increase in the number of current detectors. To address the problem, the shunt current of each inverter is detected, whereby it is possible to minimize the number of current detectors.

A first conventional example in Patent Document 1 describes an electric power converter provided with two systems each of which is a pair of a three-phase inverter and a three-phase motor, and in the electric power converter a ripple current of a capacitor connected in parallel to a DC power supply of the inverters is intended to be reduced. As means for solving this problem, Patent Document 1 mentions a method of reducing the ripple current by shifting charge and discharge periods of the capacitor from each other.

### PRIOR ART DOCUMENT

### Patent Document

### Patent Document 1: JP-2012-50252-A

### SUMMARY OF THE INVENTION

### Problems to be Solved by the Invention

Patent Document 1 discloses the method of reducing the ripple current by shifting charge and discharge periods of the capacitor from each other by shifting on-timing and off-timing of switching elements of the inverters between the systems. However, Patent Document 1 does not disclose a shunt current detection method.

To detect the pulse shunt current, it is necessary to avoid the period in which the ringing entailed by turning on and off the switching element occurs. However, a sufficient pulse width cannot be secured in a low speed, low torque condition in which an amplitude of the voltage command value is small. Owing to this, the pulse width of the shunt current relative to a width of the ringing occurrence period is small, with the result that it is impossible to accurately detect the current. To avoid this problem, there is known a method called pulse-shift to expand the pulse width of the shunt current by superimposing harmonics on the voltage command value, thereby enabling current detection.

In the pulse-shift, the pulse width of the shunt current is set in such a manner as to be able to avoid an influence of the ringing occurrence period. This pulse width is called “shunt current detection time.” To suppress an amount of the superimposed harmonics, it is desirable that the amount is set to a minimum amount by which the ringing is settled within this shunt current detection time and current value sampling time can be secured. However, the occurrence of the ringing results from on-timing and off-timing of the switching elements of the inverter. If a plurality of systems each of which is a combination of one three-phase inverter and one three-phase motor are used, it is difficult to make setting of these pieces of timing. A case in which two systems each of which is a combination of one three-phase inverter and one three-phase motor are provided and the three-phase inverters in the different systems are driven synchronously will be considered by way of example.

When voltage command values and carrier signals for the PWM are made to match one another between the synchronized inverters in the two systems, pulse widths of shunt currents also match each other therebetween. However, element delay time such as an on-delay and an off-delay varies among the switching elements, causing generation of differences in the on-timing and off-timing of the switching elements between the inverters. Therefore, to detect the shunt currents, it is required to set a pulse width to which extra time is added in consideration of a delay element resulting from these variations. Moreover, a case in which the inverters in the two systems are driven asynchronously will be considered. In this case, when the switching elements in the other system are turned on or off within the shunt current detection time of one system, the influence of the ringing prohibits accurate current detection.

### Means for Solving the Problems

In the light of the aforementioned problems, an electric power converter according to the present invention includes: a first inverter; a second inverter different from the first inverter; a first current detection section that detects a DC current of the first inverter; a second current detection section that detects a DC current of the second inverter; and a control section that controls the first inverter and the second inverter to be driven on the basis of the current detected by the first current detection section or the second current detection section. In the electric power converter, a predetermined current detection period in which the first current detection section detects the DC current of the first inverter is controlled in such a manner that the predetermined current detection period does not overlap at least timing of changing over between on-timing and off-timing of a switching element that configures the second inverter.

### Effect of the Invention

According to the present invention, it is possible to accurately detect DC input currents to an electric power converter and highly accurately control AC output currents, so that it is possible to control an output torque and a rotational speed of a rotating electrical machine with high responsiveness and high accuracy.

### BRIEF DESCRIPTION OF THE DRAWINGS

FIG. 1 is a configuration diagram of an electric power converter according to a first embodiment.

FIG. 2 is a circuit diagram of a three-phase inverter.

FIG. 3 is an explanatory diagram of shunt current waveforms before and after pulse-shift.

FIG. 4 is an explanatory diagram of a problem related to shunt current detection in inverters in two systems.

FIG. 5 shows shunt current waveforms of the inverters in the two systems according to the first embodiment.

FIG. 6 is a configuration diagram of an electric power converter according to a second embodiment.

FIG. 7 shows a relationship between a drive signal and a shunt current waveform for an inverter in one system.

FIG. 8 shows shunt current waveforms of inverters in two systems according to a third embodiment.

FIG. 9 is a configuration diagram of an electric power converter according to a fourth embodiment.

FIG. 10 is a configuration diagram of an electric power steering apparatus according to a fifth embodiment.

### MODES FOR CARRYING OUT THE INVENTION

Embodiments of an electric power converter according to the present invention will be described hereinafter with reference to the drawings. It is noted that same elements are denoted by same reference characters in the drawings and repetitive description is omitted.

### First Embodiment

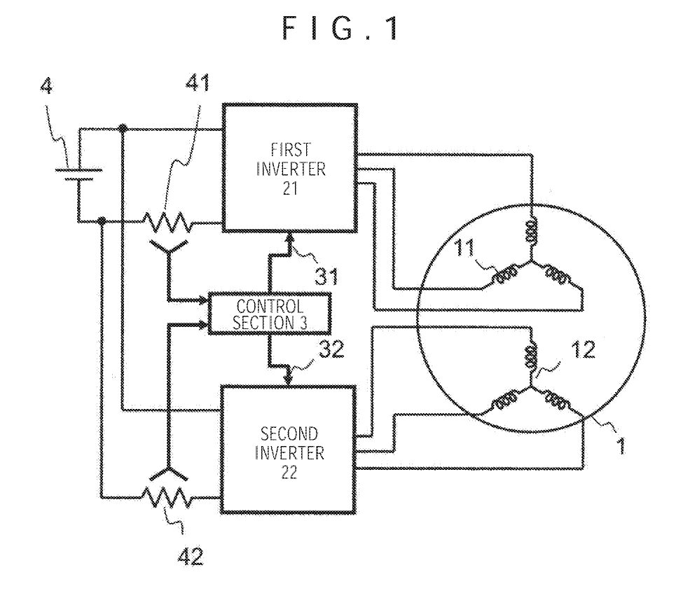

FIG. 1 shows a configuration diagram of a drive device according to a first embodiment. The drive device according to the present embodiment includes a motor 1 that includes first windings 11 and second windings that are mutually independent, a first inverter 21 connected to the first windings 11, a second inverter 22 connected to the second windings 12, a control section 3 that controls the first inverter 21 and the second inverter 22 to be driven, and a DC power supply 4 connected to the first inverter 21 and the second inverter 22.

In the motor 1, the first windings 11 and the second windings 12 configure a magnetic circuit in which one rotor is shared between the first windings 11 and the second windings 12 via a stator. The control section 3 outputs a drive signal 31 to the first inverter 21 and outputs a drive signal 32 to the second inverter 22. The DC power supply 4 may be a battery that can output DC power or may include a smoothing capacitor that suppresses a variation in the DC output power.

A first current detection section 41 is connected between the DC power supply 4 and the first inverter 21. In addition, a second current detection section 42 is connected between the DC power supply 4 and the second inverter 22. Outputs from the first current detection section 41 and the second current detection section 42 are input to the control section 3. The first current detection section 41 and the second current detection section 42 are each configured with a current detector such as a shunt resistor or a DCCT that detects a DC current.

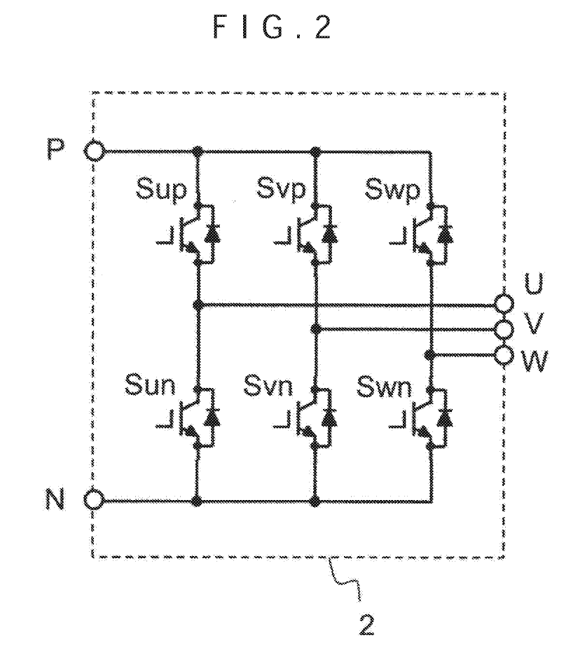

FIG. 2 is circuit diagram of a three-phase inverter. A three-phase inverter 2 shown in FIG. 2 represents a circuit configuration of each of the first inverter 21 and the second inverter 22. The three-phase inverter 2 is configured by three-phase bridge connection of switching elements such as IGBTs or MOSFETs. It is defined that DC-side terminals of the three-phase inverter 2 are a P terminal and an N terminal and that AC-side terminals thereof are a U terminal, a V terminal, and a W terminal.

The three-phase inverter 2 includes U-phase arms in which switching elements Sup and Sun are connected in series, V-phase arms in which switching elements Svp and Svn are connected in series, and W-phase arms in which switching elements Swp and Swn are connected in series. The U terminal is connected to a junction point between the Sup and the Sun. The V terminal is connected to a junction point between the Svp and the Svn. The W terminal is connected to a junction point between the Swp and the Swn.

P and N terminals of the first inverter 21 are connected to the DC power supply 4 via the first current detection section 41. P and N terminals of the second inverter 22 are connected to the DC power supply 4 via the second current detection section 42. U, V, and W terminals of the first inverter 21 are connected to the first windings 11. U, V, and W terminals of the second inverter 22 are connected to the second windings 12.

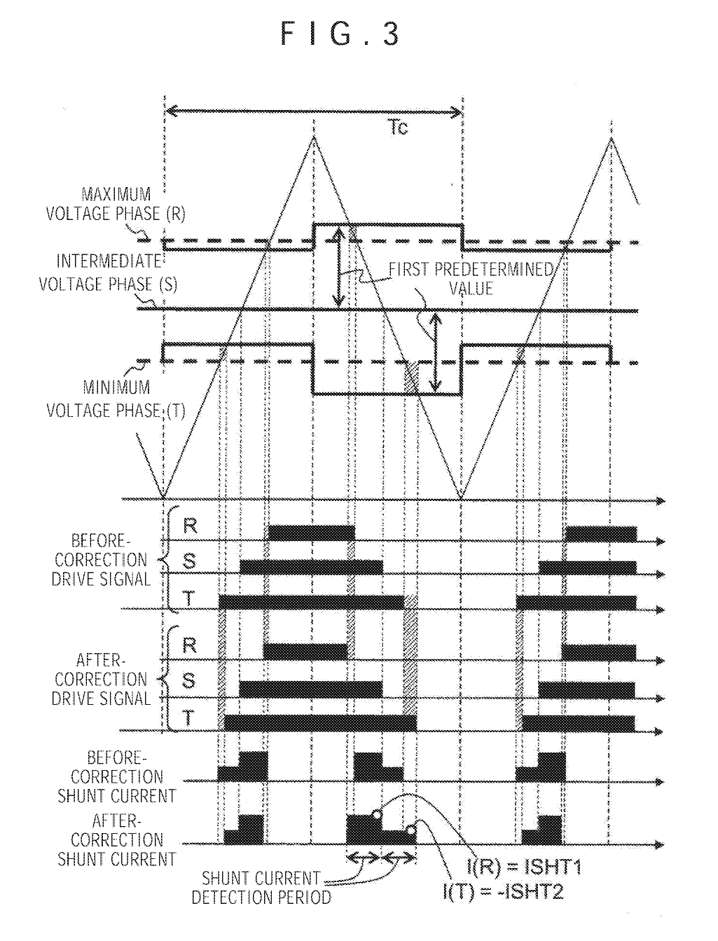

FIG. 3 is an explanatory diagram of shunt current waveforms before and after pulse-shift. Instantaneous values of three-phase voltage command values are arranged in a descending order of magnitude, and a phase in which the instantaneous value is a maximum value, a phase in which the instantaneous value is a second largest value, and a phase in which the instantaneous value is a third largest value will be hereafter referred to as maximum voltage phase, intermediate voltage phase, and minimum voltage phase, respectively. The maximum voltage phase, the intermediate voltage phase, and the minimum voltage phase will be denoted hereinafter by R phase, S phase, and T phase, respectively.

In FIG. 3, the three-phase voltage command values indicated by broken lines are values before the pulse-shift and those indicated by solid lines are values after the pulse-shift. A case in which a voltage difference between the maximum voltage phase and the intermediate voltage phase and a voltage difference between the intermediate voltage phase and the minimum voltage phase are each smaller than a first predetermined value necessary to obtain a sufficient shunt current detection period will be considered herein. In FIG. 3, as for the before-correction three-phase voltage command values indicated by the broken lines, the voltage difference between the maximum voltage phase (R phase) and the intermediate voltage phase (S phase) and the voltage difference between the intermediate voltage phase (S phase) and the minimum voltage phase (T phase) are each smaller than the first predetermined value. At this time, a pulse width of a before-correction shunt current indicated in a stepped shape in FIG. 3 is smaller than a predetermined shunt current detection period.

In this case, a correction amount is added to the voltage command values in such a manner as the three-phase voltage command values indicated by the solid lines in FIG. 3, that is, in such a manner that the voltage difference between the maximum voltage phase (R phase) and the intermediate voltage phase (S phase) and the voltage difference between the intermediate voltage phase (S phase) and the minimum voltage phase (T phase) are each equal to the first predetermined value. A pulse width of an after-correction shunt current thereby becomes equal to the shunt current detection period. Once the shunt current detection period can be secured, the shunt current can be detected upon settling of ringing, and a detected current ISHT1 is a phase current I(R) of the R phase. The same thing is true for the T phase that is the minimum voltage phase; a shunt current ISHT2 detected by correcting the voltage command values is a phase current I(T) of the T phase. Three-phase currents are determined by obtaining I(S) from the detected I(R) and I(T) as represented by Equation (1).

[Equation 1]

I(S)=−{I(R)+I(T)} (1)

It is noted that adding the correction amount means that voltages different from the original voltage command values are applied. Therefore, an addition is subtracted from the voltage command values, thereby making an average value of the after-correction voltage command values match before-correction voltages and making the applied voltage equal to a desired voltage command value. In FIG. 3, the correction amount is divided in half to correspond to each of a first half and a second half of a carrier cycle to which the correction amount is added, thereby performing subtraction. The subtraction suffices if the average value of the after-correction voltage command values matches the before-correction voltage command values, and addition and subtraction may be repeated for every half cycle of the carrier cycle. As obvious from FIG. 3, the correction amount is a harmonic component for the voltage command values. Because of the harmonics, the correction amount often becomes an electromagnetic noise, depending on a frequency of the harmonics to be superimposed. To address this problem, it is necessary to maintain quietness by holding down an amount of superimposition to a minimum.

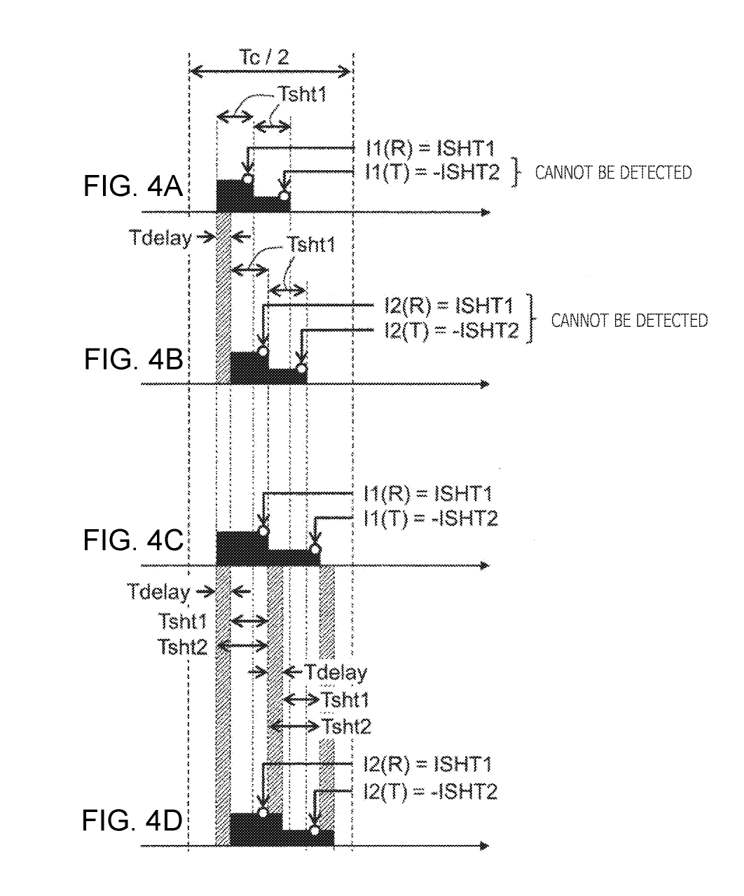

FIG. 4 is an explanatory diagram of a problem related to shunt current detection in the three-phase inverters in the two systems. Referring to FIGS. 4(a) and 4(b), shunt current waveforms in a case of synchronously driving the first inverter 21 and the second inverter 22 will first be described. FIG. 4(a) shows a shunt current waveform of the first inverter 21, and FIG. 4(b) shows a shunt current waveform of the second inverter 22. FIG. 4 shows only shunt current detection periods within a half period of a carrier cycle Tc.

In FIG. 4(a), a pulse width of the shunt current of the first inverter 21 is secured within time which is a shunt current detection period Tsht1 and within which each of I1(R) and I1(T) is detected. In FIG. 4(b), delay time from rising of the shunt current shown in FIG. 4(a) is denoted by Tdelay, and shunt currents of the second inverter 22 are shown. As for the shunt currents shown in FIGS. 4(a) and 4(b), the periods Tsht1 of the first inverter shift from the periods Tsht1 of the second inverter by Tdelay, so that the I1(T) of the first inverter and I2(R) and I2(T) of the second inverter cannot be detected.

To solve this problem, a shunt current detection period Tsht2 obtained by adding the Tdelay to the Tsht1 is defined anew as represented by Equation (2).

[Equation 2]

Tsht2=Tsht1+Tdelay (2)

FIG. 4(c) shows a shunt current waveform of the first inverter 21 for which the periods Tsht2 are secured, and FIG. 4(d) is a shunt current waveform of the second inverter 22 for which the periods Tsht2 are secured. The shunt currents of the second inverter 22, in particular, are detected at timing of securing the periods Tsht1 shown in FIG. 4(d). It is thereby possible to detect the shunt currents without the influence of the ringing. With this method, however, a correction amount is needed for the Tsht2 and the Tsht2 becomes redundant compared with the Tsht1, which disadvantageously increases the electromagnetic noise, compared with a case of securing the Tsht1.

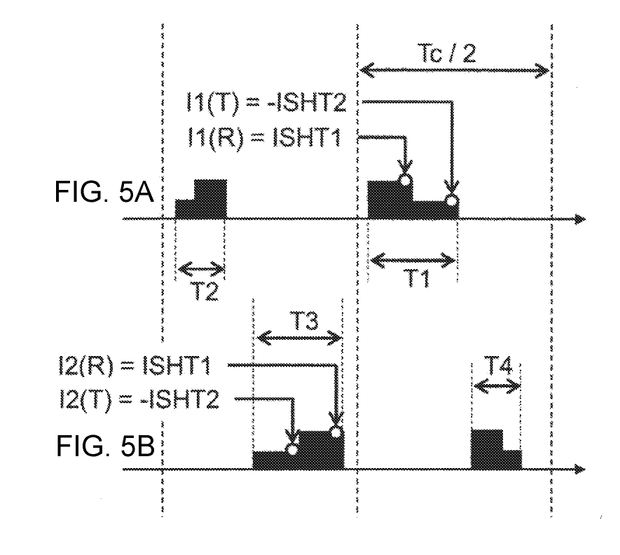

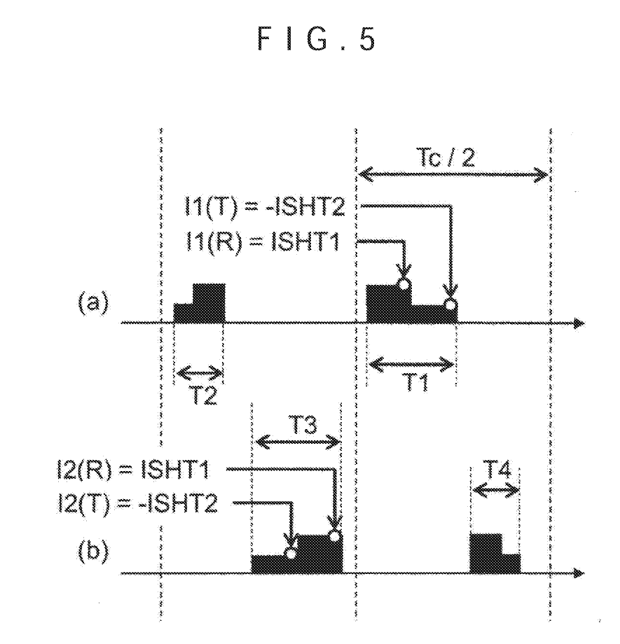

FIG. 5 shows shunt current waveforms of the inverters in the two systems according to the present embodiment. FIG. 5(a) shows a shunt current waveform of the first inverter 21, and FIG. 5(b) shows a shunt current waveform of the second inverter 22. In FIG. 5(a), a shunt current detection period is denoted by T1, and a shunt current carrying period other than the period T1 is denoted by T2. Likewise, in FIG. 5(b), a shunt current detection period is denoted by T3, and a shunt current carrying period other than the period T3 is denoted by T4.

A combination of the periods T1 and T2 of the first inverter 21 is one by pairing the period T1 in which the pulse width is expanded to detect the shunt current with the period T2 in which the pulse width is reduced to make the average value of the after-correction voltage command values match the before-correction voltage command values. The period T2 is reduced in a first half cycle of the carrier cycle while the period T1 is expanded in a second half cycle Tc/2 thereof, whereby it is possible to secure a period in which the shunt current is not carried.

The periods T3 and T4 of the second inverter 22 are periods in which the shunt current is carried and which do not overlap the periods T1 and T2 of the first inverter 21. More specifically, the period T3 in which the shunt current of the second inverter 22 is detected is combined with the period T2 in which the pulse width is reduced in the first half cycle of the carrier cycle. The period T4 in which the pulse width is reduced is combined with the period T1 in which the pulse width is expanded in the second half cycle of the carrier cycle.

It is thereby possible to shift the on-timing and off-timing of the switching elements that cause disturbance of current detection from the periods T1 and T3 in which the shunt currents are detected, so that it is possible to detect accurate current values. In addition, it is thereby possible to minimize the correction amount and suppress an increase of the electromagnetic noise.

### Second Embodiment

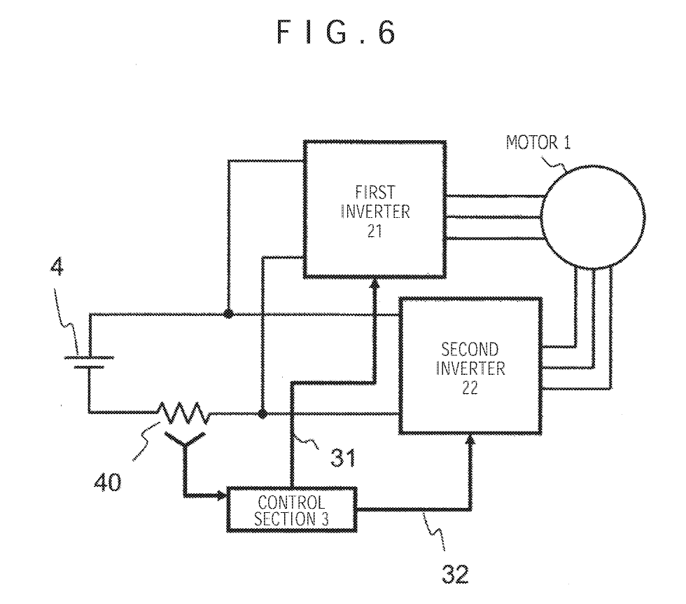

FIG. 6 shows a configuration of a drive device according to a second embodiment. FIG. 6 shows a configuration such that a current detection section 40 is shared between the first inverter 21 and the second inverter 22, differently from the configuration of FIG. 1. With the present configuration, pulse AC currents of the first inverter 21 and the second inverter 22 are carried to the current detection section 40 configured with a shunt resistor or the like. At the on-timing and off-timing of the switching elements shown in FIG. 4, an amplitude of the shunt current is a value that is obtained by adding up the currents of the first inverter 21 and the second inverter 22 and that is inseparable. However, at the temporally divided on-timing and off-timing of the switching elements shown in FIG. 5, the currents of the first inverter 21 and the second inverter 22 are carried at different timing, so that the amplitude of the shunt current is not the added value but is separable. Using this characteristic enables the currents of the first inverter 21 and the second inverter 22 to be obtained from the common current detection section 40.

According to the present embodiment, the current detection sections of the shunt resistors or the like that are needed individually for the first inverter 21 and the second inverter 22 can be changed to the common current detection section 40 shared between the first inverter 21 and the second inverter 22. Therefore, it is possible to achieve cost reduction by reducing the number of components and size reduction by reducing an area for installing patterns and components.

### Third Embodiment

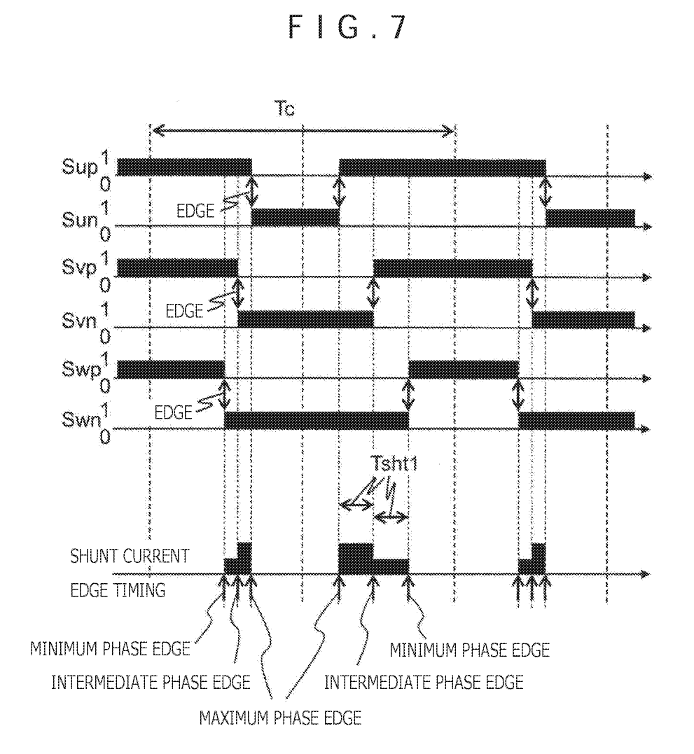

FIG. 7 shows a relationship between a drive signal and a shunt current waveform for an inverter in a certain system. FIG. 7 shows on-states and off-states of the switching elements Sup, Sun, Svp, Svn, Swp, and Swn at moments at which a U phase becomes the maximum voltage phase (R phase), a V phase becomes the intermediate voltage phase (S phase), and a W phase becomes the minimum voltage phase (T phase). In FIG. 7, “1” represents that the switching element is turned on and “0” represents that the switching element is turned off.

With the circuit configuration of FIG. 1 or 6, the switching elements that configure the inverter are changed over in response to the drive signal 31 or 32. When upper arms Sup, Svp, and Swp are changed over from the off-state to the on-state, lower arms Sun, Svn, and Swn paired with the upper arms are changed over from the on-state to the off-state. The changeover between the on-state and the off-state at this time is referred to as edge. Pieces of edge timing of the shunt currents relative to pulse currents include a maximum phase edge, an intermediate phase edge, and a minimum phase edge shown in a lowermost stage of FIG. 7.

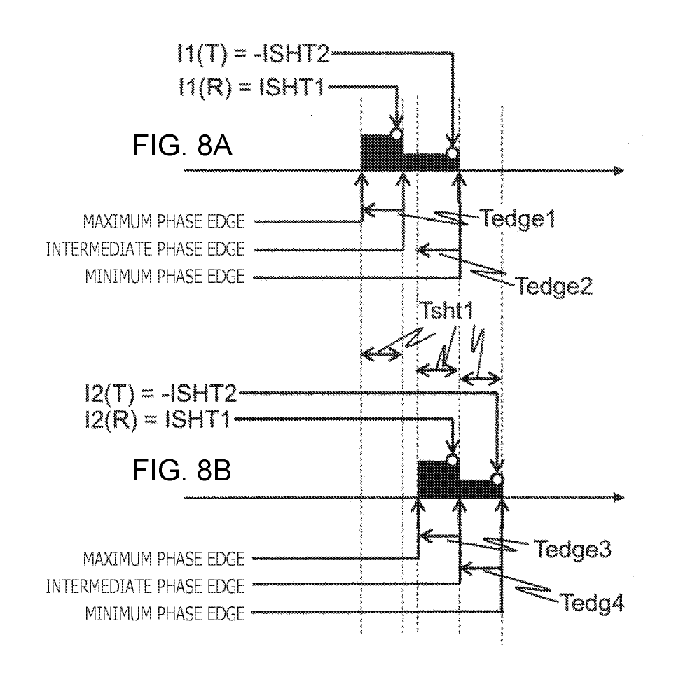

FIG. 8 shows shunt current waveforms of the inverters in the two systems according to the present embodiment. FIG. 8 shows both the timing of detecting the shunt current and the edge timing. FIG. 8(a) shows the shunt current waveform of the first inverter 21, and FIG. 8(b) shows the shunt current waveform of the second inverter 22.

In FIG. 8, the pieces of the edge timing are the maximum phase edge, the intermediate phase edge, and the minimum phase edge in an ascending order of occurrence timing. To detect the shunt currents, the shunt current detection periods Tsht1 are necessary, and it is significant to prevent the edge timing of the first inverter 21 and the second inverter 22 from occurring in the periods. To address the challenge, shunt current detection periods Tsht1 are each secured from later occurrence timing to earlier occurrence timing that are two pieces of adjacent edge timing. In FIG. 8, among the pieces of the edge timing of the first inverter 21, a period from the intermediate phase edge to the maximum phase edge is denoted by Tedge1 and a period from the minimum phase edge to the intermediate phase edge is denoted by Tedge2. Likewise, among the pieces of the edge timing of the second inverter 22, periods Tedge3 and Tedge4 are defined. It is possible to accurately detect the shunt currents by preventing the edge timing of both the first inverter 21 and the second inverter 22 from occurring within the periods Tedge1 to Tedge4.

According to the present embodiment, it is possible to avoid interference between the systems against the shunt current detection periods Tsht1, and it is possible to acquire accurate current values and eventually control the electric power converter with high performance.

### Fourth Embodiment

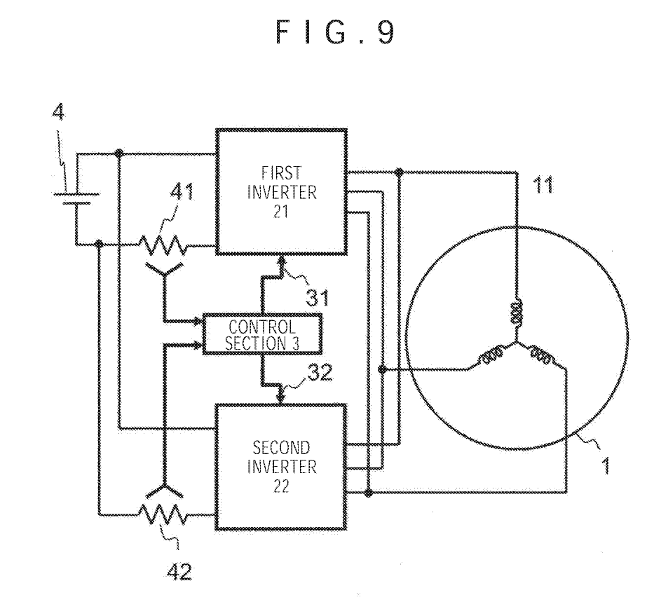

FIG. 9 is a configuration diagram of a drive device according to a fourth embodiment. FIG. 9 shows a configuration such that the first windings 11 of the motor 1 according to the first embodiment shown in FIG. 1 are shared between the first inverter 21 and the second inverter 22. With this configuration, the first inverter 21 and the second inverter 22 are connected in parallel and current capacities of the inverters can be added up to be doubled.

Three-phase AC outputs from the first inverter 21 are detected by the first current detection section 41, and three-phase AC outputs from the second inverter 22 are detected by the second current detection section 42.

### Fifth Embodiment

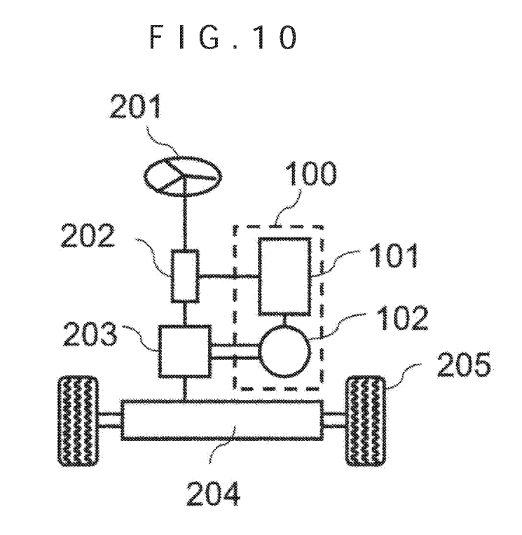

FIG. 10 is a configuration diagram of an electric power steering apparatus according to a fifth embodiment. The electric power steering apparatus operates a steering wheel 201, thereby actuating a steering mechanism 204 via a torque sensor 202 and a steering assist mechanism 203, rolling tires 205 to change a direction of the tires 205, and steering a vehicle travel direction. The steering assist mechanism 203 outputs a steering force for actuating the steering mechanism 204 by a resultant force between a manually-operated steering force of the steering wheel 201 and a power-assisted steering force obtained from a drive device 100. An electric power converter 101 of the drive device 100 determines a shortfall in the manual steering force from an output obtained by the torque sensor 202 as the power-assisted steering force, and the drive device 100 drives a motor 102.

The motor 102 in FIG. 10 corresponds to the motor 1 in FIGS. 1, 6, 9, and the like. Furthermore, the electric power converter 101 in FIG. 10 corresponds to inverter sections and the control section in FIGS. 1, 6, 9, and the like.

According to the present embodiment, detection values of shunt currents of the electric power converter 101 are accurately detected, thereby making it possible to drive the motor 102 with high performance and eventually, smoothly generate the power-assisted steering force with respect to an operation amount of the steering wheel 201.

### DESCRIPTION OF REFERENCE CHARACTERS

1: Motor
11: First windings
12: Second windings
2: Three-phase inverter
21: First inverter
22: Second inverter
3: Control section
31: Drive signal
32: Drive signal
4: DC power supply
40: Current detection section
41: First current detection section
42: Second current detection section
100: Drive device
101: Electric power converter
102: Motor
201: Steering wheel
202: Torque sensor
203: Steering assist mechanism
204: Steering mechanism
205: Tire

1. An electric power converter, comprising:
a first inverter;
a second inverter different from the first inverter;
a first current detection section that detects a DC current of the first inverter;
a second current detection section that detects a DC current of the second inverter; and
a control section that controls the first inverter and the second inverter to be driven on the basis of the current detected by the first current detection section or the second current detection section, wherein
a predetermined current detection period in which the first current detection section detects the DC current of the first inverter is controlled in such a manner that the predetermined current detection period does not overlap at least timing of changing over between on-timing and off-timing of a switching element that configures the second inverter.

2. The electric power converter according to claim 1, wherein
the control section controls the first inverter to be driven in such a manner that a carrying period in which a current is carried to the first current detection section during a half cycle of a carrier cycle is equal to or longer than a period necessary for the first current detection section to detect the current, and
the predetermined current detection period of the first current detection section is the period necessary to detect the current.

3. The electric power converter according to claim 1, wherein
the predetermined current detection period in which the first current detection section detects the DC current of the first inverter is controlled in such a manner that the predetermined current detection period does not overlap a period in which a current is carried to the second current detection section.

4. The electric power converter according to claim 1, wherein
a predetermined current detection period in which the second current detection section detects the DC current of the second inverter is controlled in such a manner that the predetermined current detection period does not overlap at least timing of changing over between on-timing and off-timing of a switching element that configures the first inverter.

5. The electric power converter according to claim 4, wherein
the control section controls the second inverter to be driven in such a manner that a carrying period in which a current is carried to the second current detection section during a half cycle of a carrier cycle is equal to or longer than a period necessary for the second current detection section to detect the current, and
the predetermined current detection period of the second current detection section is the period necessary to detect the current.

6. The electric power converter according to claim 4, wherein
the predetermined current detection period in which the second current detection section detects the DC current of the second inverter is controlled in such a manner that the predetermined current detection period does not overlap a period in which the current is carried to the first current detection section.

7. The electric power converter according to claim 6, wherein
when the carrier cycle is divided into a first period and a second period each corresponding to a half cycle,
the control section controls the first inverter to be driven in such a manner that a period in which the current is carried to the first current detection section within the second period is longer than a period in which the current is carried to the first current detection section within the first period, and
the control section further controls the second inverter to be driven in such a manner that a period in which the current is carried to the second current detection section within the second period is shorter than a period in which the current is carried to the second current detection section within the first period.

8. The electric power converter according to claim 1, comprising
one current detection section that functions as the first current detection section and functions as the second current detection section, wherein
a predetermined current detection period in which the current detection section detects the DC current of the first inverter is controlled in such a manner that the predetermined current detection period does not overlap a period in which a current is carried to the second current detection section, and
a predetermined current detection period in which the current detection section detects the DC current of the second inverter is controlled in such a manner that the predetermined current detection period does not overlap a period in which a current is carried to the first current detection section.

9. The electric power converter according to claim 1, wherein
the first inverter is connected to first windings of a rotating electrical machine,
the second inverter is connected to second windings provided independently of the first windings of the rotating electrical machine, and
an output from the first inverter is controlled independently of an output from the second inverter.

10. An electric power steering apparatus, comprising:
the electric power converter according to claim 1; and
a rotating electrical machine, output power of the rotating electrical machine being controlled by the electric power converter, and the rotating electrical machine assisting in steering by the output power.
